(19) United States
(12) Patent Application Publication
(10) Pub. No.: US 2026/0063972 A1
(43) Pub. Date: Mar. 5, 2026

(54) LENS DEVICE

(71) Applicant: Chicony Electronics Co., Ltd., New Taipei City (TW)

(72) Inventors: Yi-Sing Jiang, New Taipei City (TW); Pei-Sheng Tsai, New Taipei City (TW)

(73) Assignee: Chicony Electronics Co., Ltd., New Taipei City (TW)

(21) Appl. No.: 18/948,277

(22) Filed: Nov. 14, 2024

(30) Foreign Application Priority Data
Aug. 30, 2024 (TW) 113132897

(51) Int. Cl. G03B 17/08; G03B 17/12

(52) U.S. Cl. CPC G03B 17/08; G03B 17/12

(57) ABSTRACT

A lens device includes a housing, a lens module, a cover, and an elastic member. The housing includes an opening and an accommodation space communicated with the opening. The lens module is disposed in the housing and is located in the accommodation space. The cover is disposed in the opening and is located above the lens module. The elastic member includes a first annular section and a second annular section. The first annular section is disposed between the cover and the housing and contacts the cover and the housing, and the second annular section contacts a peripheral side of the lens module, so that a sealed area is formed between the cover, the elastic member, and the lens module.

### CROSS-REFERENCE TO RELATED APPLICATION

This application claims the priority benefit of Taiwan application serial no. 113132897, filed on Aug. 30, 2024. The entirety of the above-mentioned patent application is hereby incorporated by reference herein and made a part of this specification.

### BACKGROUND

### Technical Field

The disclosure relates to a lens device, and in particular to an anti-fog lens device.

### Description of Related Art

The outdoor equipment (for example, an outdoor monitor) is disposed outdoors. Rainwater may penetrate into the lens device of the outdoor monitor, causing the lens or the glass cover in the lens device to fog up, which affects the quality of images captured by the lens device.

### SUMMARY

The disclosure provides a lens device, which can reduce the probability of water vapor penetrating into a space between a cover and a lens.

A lens device of the disclosure includes a housing, a lens module, a cover, and an elastic member. The housing includes an opening and an accommodation space communicated with the opening. The lens module is disposed on housing and is located in the accommodation space. The cover is disposed in the opening and is located above the lens module. The elastic member includes a first annular section and a second annular section. The first annular section is disposed between the cover and the housing and contacts the cover and the housing, and the second annular section contacts a peripheral side of the lens module, so that a sealed area is formed between the cover, the elastic member, and the lens module.

In an embodiment of the disclosure, the second annular section includes a surrounding wall portion and an annular abutment portion connected to the surrounding wall portion. The surrounding wall portion surrounds the lens module, and the annular abutment portion abuts the peripheral side.

In an embodiment of the disclosure, the housing includes an inner platform, the inner platform surrounds the lens module, the first annular section is supported on the inner platform, and the second annular section is located between the inner platform and the lens module.

In an embodiment of the disclosure, there is a first deformable space between the surrounding wall portion and the inner platform.

In an embodiment of the disclosure, the surrounding wall portion has a first inner diameter, the first inner diameter is greater than an outer diameter of the lens module, the annular abutment portion has a second inner diameter when not squeezed, and the outer diameter of the lens module is greater than the second inner diameter.

In an embodiment of the disclosure, the annular abutment portion obliquely extends from a distal end of the surrounding wall portion toward a direction of the opening and is located between the surrounding wall portion and the peripheral side, so that there is a second deformable space between the annular abutment portion and the surrounding wall portion.

In an embodiment of the disclosure, the annular abutment portion is in a C shape, and an opening of the annular abutment portion is away from the peripheral side.

In an embodiment of the disclosure, the second annular section is tapered toward a direction away from the opening along an optical axis of the lens module.

In an embodiment of the disclosure, the second annular section has a maximum inner diameter and a minimum inner diameter when not squeezed, the maximum inner diameter is greater than an outer diameter of the lens module, and the outer diameter of the lens module is greater than the minimum inner diameter.

In an embodiment of the disclosure, a thickness of the second annular section is less than a thickness of the first annular section.

In an embodiment of the disclosure, the housing includes an inner wall and an inner platform disposed on the inner wall, the inner wall and the inner platform surround the lens module, the first annular section is supported on the inner platform, and the second annular section is located between the inner platform and the lens module.

In an embodiment of the disclosure, the elastic member further includes a third annular section connected between the first annular section and the second annular section and obliquely expanding toward a direction of the opening along an optical axis of the lens module.

In an embodiment of the disclosure, the first annular section, the second annular section, and the third annular section of the elastic member are integrally formed.

In an embodiment of the disclosure, the inner platform includes a planar portion, the first annular section includes a first portion attached to a lower surface of the cover, and the first portion is sandwiched between the lower surface of the cover and the planar portion.

In an embodiment of the disclosure, the first annular section includes a second portion, and the second portion is sandwiched between a side surface of the cover and the inner wall.

In an embodiment of the disclosure, a thickness of the second portion is less than a thickness of the first portion.

Based on the above, the first annular section of the elastic member of the lens device of the disclosure is disposed between the cover and the housing and contacts the cover and the housing, and the second annular section of the elastic member contacts the peripheral side of the lens module, so that the sealed area is formed between the cover, the elastic member, and the lens module, which can reduce the probability of water vapor penetrating into between the cover and the lens module to provide an anti-fog effect.

### BRIEF DESCRIPTION OF THE DRAWINGS

FIG. 1 is a schematic view of an appearance of a lens device according to an embodiment of the disclosure.

FIG. 2 is a cross-sectional schematic view of the lens device of FIG. 1.

FIG. 3 and FIG. 4 are exploded schematic views of the lens device of FIG. 1 from different perspectives.

FIG. 5 and FIG. 6 are partial cross-sectional schematic views of various lens devices according to other embodiments of the disclosure.

### DESCRIPTION OF THE EMBODIMENTS

It should be noted that in the description of the embodiments, the so-called “first” and “second” are used to describe different elements, and the elements are not limited by such predicates. In addition, for the convenience and clarity of explanation, the thickness or the size of each element in the drawings is exaggerated, omitted, or schematically expressed to facilitate understanding and reading by persons skilled in the art, and the size of each element is not entirely the actual size and is not used to limit the implementation of the disclosure, so there is no technical substantive significance. Any structural modifications, changes in proportions, or adjustments in size should still fall within the scope of the technical content of the disclosure without affecting the effects that the disclosure can produce and the purposes that can be achieved. The same reference numerals will be used throughout the drawings to refer to the same or similar elements.

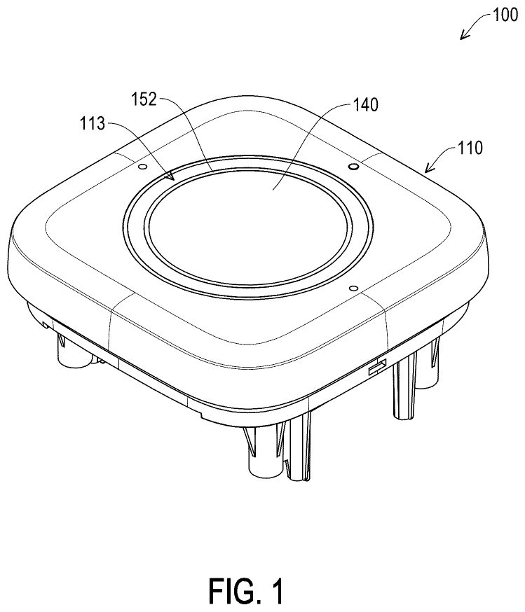

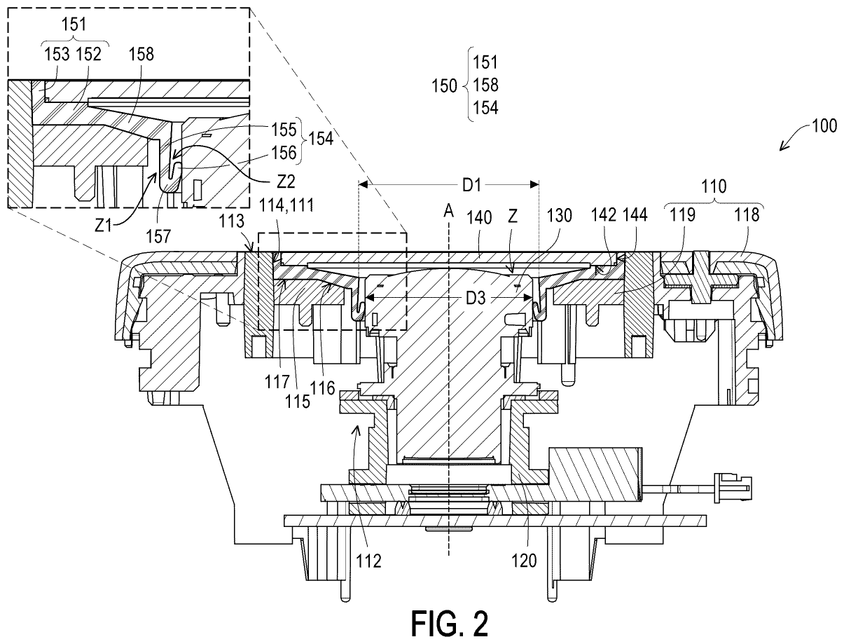

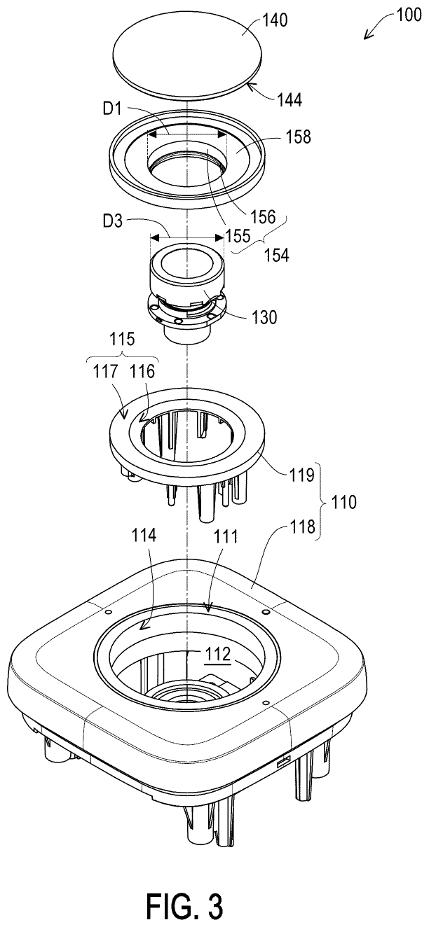

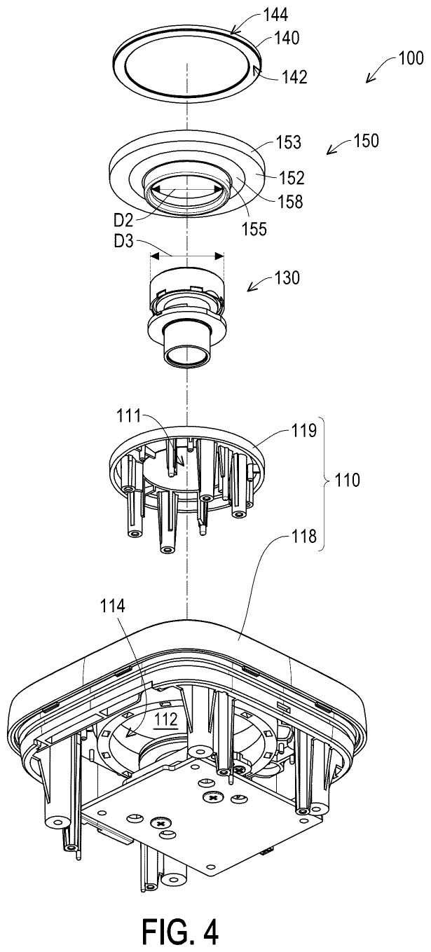

FIG. 1 is a schematic view of an appearance of a lens device according to an embodiment of the disclosure. FIG. 2 is a cross-sectional schematic view of the lens device of FIG. 1. FIG. 3 and FIG. 4 are exploded schematic views of the lens device of FIG. 1 from different perspectives. Refer to FIG. 1 to FIG. 4. A lens device 100 of the embodiment may be, for example, applied to an outdoor monitor, but not limited thereto. The lens device 100 includes a housing 110, a holder 120, a lens module 130, a cover 140, and an elastic member 150. The cover 140 may be transparent, translucent, partially light transmitting, or only allow light rays of a specific frequency to pass through, and the type of the cover 140 is not limited thereto.

As can be seen from FIG. 3, in the embodiment, the housing 110 includes a first shell 118 and a second shell 119. The first shell 118 includes an inner wall 114 and an opening 111 and an accommodation space 112 surrounded by the inner wall 114. The opening 111 is communicated with the accommodation space 112.

The second shell 119 is disposed in the accommodation space 112 and includes an inner platform 115. In the embodiment, the inner platform 115 is annular, and the annular shape is not limited to a circular ring, a square ring, or an elliptical ring, as long as the annular shape is a closed annular shape. As can be seen from FIG. 2, the inner platform 115 is disposed on an inner side of the inner wall 114. In some embodiments, the inner platform 115 is connected to the inner wall 114. In the embodiment, the housing 110 is composed of the first shell 118 and the second shell 119, and multiple structures may be allocated onto the first shell 118 and the second shell 119, so manufacturing is relatively simple. Of course, in other embodiments, the housing 110 may also have only a single shell.

As shown in FIG. 2, the lens module 130 is disposed in the housing 110 and is located in the accommodation space 112, and the holder 120 is disposed in the housing 110 and is located in the accommodation space 112. Specifically, the lens module 130 is disposed on the holder 120 and is located in the accommodation space 112. The inner wall 114 and the inner platform 115 of the housing 110 surround the lens module 130. The cover 140 is disposed in the opening 111 and is located above the lens module 130 to protect the lens module 130 and be adapted to allow light rays of a specific frequency to pass through and enter the lens module 130.

Generally speaking, since the material of the cover 140 is, for example, plastic or glass, and the material of the housing 110 is, for example, plastic or metal, the materials of the cover 140 and the housing 110 are hard, that is, inflexible. If the cover 140 directly contacts the housing 110, there will inevitably be a small gap between the cover 140 and the housing 110, so outdoor water vapor may easily penetrate into the lens device 100 from the gap between the cover 140 and the inner wall 114 of the housing 110.

The lens device 100 of the embodiment is provided with the elastic member 150 between the cover 140 and the housing 110, the elastic member 150 has flexibility, and the hardness of the elastic member 150 is less than the hardness of any one of the housing 110, the cover 140, and the lens module 130. In the embodiment, the material of the elastic member 150 is rubber or silicone. Such a configuration allows the elastic member 150 to be sandwiched between the cover 140 and the housing 110. The elastic member 150 may be elastically deformed, and the cover 140 and the housing 110 may be closely combined with the elastic member 150 without leaving any gap, which can ensure that water vapor does not penetrate from the gap between the cover 140 and the inner wall 114 of the housing 110. The elastic member 150 of the embodiment will be described in detail in the following paragraphs.

As shown in FIG. 2, the elastic member 150 includes a first annular section 151 and a second annular section 154. The shapes of the first annular section 151 and the second annular section 154 are not limited to circular rings, square rings, or elliptical rings, as long as the shapes are closed ring shapes. The first annular section 151 is disposed between the cover 140 and the housing 110 and contacts the cover 140 and the housing 110.

Particularly, in the embodiment, the first annular section 151 is supported on the inner platform 115 and contacts the inner wall 114 and the cover 140 to prevent water vapor from penetrating from between the cover 140 and the housing 110.

Specifically, the inner platform 115 includes a planar portion 117. The first annular section 151 includes a first portion 152 and a second portion 153. The first portion 152 is attached to a lower surface 142 of the cover 140, and the first portion 152 is sandwiched between the lower surface 142 of the cover 140 and the planar portion 117.

The second portion 153 is sandwiched between a side surface 144 of the cover 140 and the inner wall 114. In the embodiment, the second portion 153 is flush with the cover 140 and an outer surface 113 of the housing 110, so that the appearance is complete and appealing, but not limited thereto. In addition, in the embodiment, the thickness of the second portion 153 is less than the thickness of the first portion 152, so that the first portion 152 provides better support to the cover 140.

In other embodiments, the first annular section 151 may also only have the first portion 152 sandwiched between the lower surface 142 of the cover 140 and the planar portion 117 without the second portion 153 sandwiched between the side surface 144 of the cover 140 and the inner wall 114. In other words, the side surface 144 of the cover 140 may be directly located next to the inner wall 114, that is, the side surface 144 of the cover 140 directly contacts the inner wall 114 of the housing 110, and the first portion 152 located between the lower surface 142 of the cover 140 and the planar portion 117 may still prevent water vapor from penetrating into the lens device 100.

The second annular section 154 is located between the inner platform 115 and the lens module 130 and contacts a peripheral side of the lens module 130, so that a sealed area Z is formed between the cover 140, the elastic member 150, and the lens module 130, which can reduce the probability of water vapor penetrating into between the cover 140 and the lens module 130. Therefore, the lens device 100 has an anti-fog function.

Specifically, in the embodiment, the second annular section 154 includes a surrounding wall portion 155 and an annular abutment portion 156 connected to the surrounding wall portion 155. In the embodiment, the annular abutment portion 156 is bent and connected to the surrounding wall portion 155. The surrounding wall portion 155 is separated from the inner platform 115, and there is a gap between the surrounding wall portion 155 and the inner platform 115. The surrounding wall portion 155 is isolated/separated from the inner platform 115, so that there is a first deformable space Z1 between the surrounding wall portion 155 and the inner platform 115.

In addition, the surrounding wall portion 155 surrounds and is isolated from the lens module 130, and the annular abutment portion 156 abuts the peripheral side of the lens module 130. Specifically, in the embodiment, the annular abutment portion 156 obliquely extends upward from a distal end 157 of the surrounding wall portion 155 toward the direction of the opening 111 and is located between the surrounding wall portion 155 and the peripheral side of the lens module 130, so that there is a second deformable space Z2 between the annular abutment portion 156 and the surrounding wall portion 155.

In the embodiment, the lens device 100 has the first deformable space Z1 and the second deformable space Z2 to allow the annular abutment portion 156 to deform more freely during the process of abutting the peripheral side of the lens module 130. Of course, in an embodiment, the lens device 100 may also have only the first deformable space Z1 or only the second deformable space Z2.

The surrounding wall portion 155 has a first inner diameter D1, and the first inner diameter D1 is greater than an outer diameter D3 of the lens module 130. Here, the outer diameter D3 refers to the maximum outer diameter of a part of the lens module 130 assembled into the surrounding wall portion 155. Specifically, in the embodiment, the outer diameter D3 is an outer diameter of a lens retainer, but not limited thereto. Therefore, during assembly, the lens module 130 may be easily assembled into the surrounding wall portion 155.

In addition, as shown in FIG. 4, the annular abutment portion 156 has a second inner diameter D2 when not squeezed, and the outer diameter D3 of the lens module 130 is greater than the second inner diameter D2. Therefore, during assembly, the annular abutment portion 156 is squeezed and deformed by the peripheral side of the lens module 130 to firmly abut the peripheral side of the lens module 130 to ensure the sealing performance of the sealed area Z.

In addition, as can be seen from FIG. 2, the thickness of the second annular section 154 is less than the thickness of the first annular section 151. Therefore, the second annular section 154 may be easily deformed to be fitted more closely to the peripheral side of the lens module 130. Although the second annular section 154 contacts the peripheral side of the lens module 130, due to the flexibility of the elastic member 150, the elastic member 150 does not exert an excessive force (lateral force) to the lens module 130, so while ensuring the sealing performance of the sealed area Z and preventing water vapor from penetrating into between the cover 140 and the lens module 130, the lens module 130 may also be prevented from being pushed by an external force, which causes the focus point to shift, thereby affecting shooting clarity.

Furthermore, in the embodiment, the elastic member 150 may further include a third annular section 158 connected between the first annular section 151 and the second annular section 154. In the embodiment, the first annular section 151, the second annular section 154, and the third annular section 158 of the elastic member 150 are integrally formed.

The third annular section 158 is supported on the inner platform 115 and obliquely expands toward the direction of the opening 111 along an optical axis A of the lens module 130. Specifically, as can be seen from the cross-section of FIG. 2, parts of the third annular section 158 on the left and right sides of the lens module 130 obliquely expands toward the direction of the opening 111. The expanded angle is greater than or equal to the field of view of the central lens module 130 to prevent external light rays from being blocked by the elastic member 150 (the third annular section 158), which affects shooting quality and light collection effect of the lens module 130.

It is worth mentioning that in the embodiment, the inner platform 115 includes an inclined portion 116, and the third annular section 158 contacts and conforms to the inclined portion 116 and obliquely expands toward the direction of the opening 111. In other embodiments, the third annular section 158 may also have different thicknesses to obliquely expand toward the direction of the opening 111.

The lens device 100 may be assembled through the steps described below. First, the second shell 119 is assembled to the first shell 118 to complete the assembly of the housing 110. Next, the elastic member 150 is disposed on the inner platform 115. Next, the cover 140 is disposed on the elastic member 150, so that the cover 140 contacts the elastic member 150 (for example, the first annular section 151), that is, the elastic member 150 is sandwiched between the housing 110 and the cover 140. Finally, the lens module 130 is extended upward into the housing 110 from below the first shell 118, so that the annular abutment portion 156 abuts the peripheral side of the lens module 130. Of course, in other embodiments, the order of assembly is not limited thereto. For example, before the cover 140 is disposed on the elastic member 150, the lens module 130 may be assembled into the housing 110 and disposed into the elastic member 150 from the opening 111.

As can be seen from the above, in the embodiment, the second annular section 154 abuts the peripheral side of the lens module 130 through the annular abutment portion 156 obliquely extending from the distal end 157 of the surrounding wall portion 155 toward the direction of the opening 111, so that the sealed area Z is formed between the cover 140, the elastic member 150, and the lens module 130 to prevent water vapor from entering. Of course, the shape of the second annular section 154 is not limited thereto. Different forms of the second annular section 154 are illustrated below.

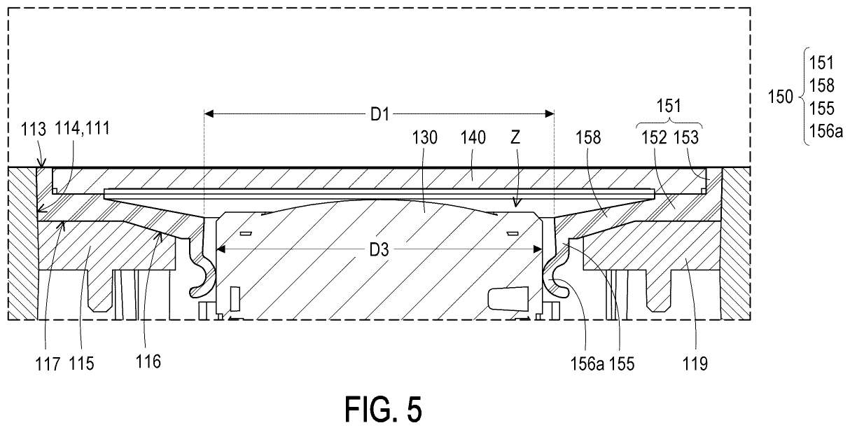

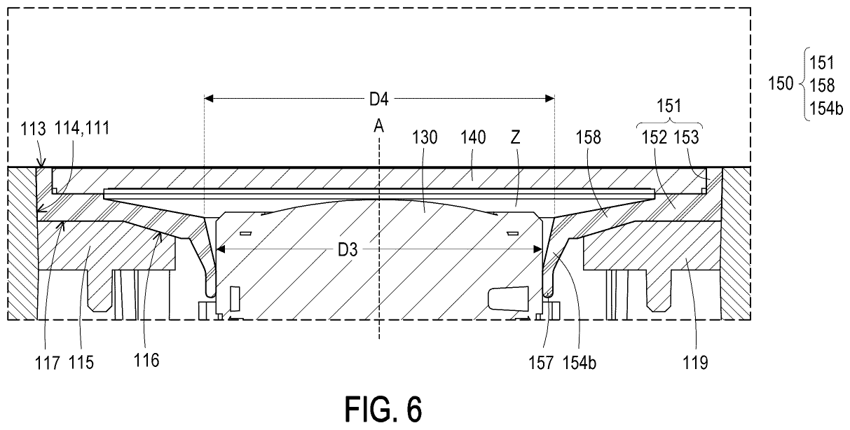

FIG. 5 and FIG. 6 are partial cross-sectional schematic views of various lens devices according to other embodiments of the disclosure. Refer to FIG. 5. In the embodiment, an annular abutment portion 156a is in a C shape, and the opening of the annular abutment portion 156a is away from the peripheral side of the lens module 130. Therefore, the annular abutment portion 156a abuts the peripheral side of the lens module 130 at the protruding end point, so that the sealed area Z is formed between the cover 140, the elastic member 150, and the lens module 130 to prevent water vapor from entering.

Refer to FIG. 6. In the embodiment, an inner diameter of a second annular section 154b is tapered toward a direction away from the opening 111 along the optical axis A of the lens module 130. In FIG. 6, the inner diameter of the second annular section 154b at the distal end 157 is squeezed and enlarged by the peripheral side of the lens module 130 to be fitted to the peripheral side of the lens module 130.

The second annular section 154b has a maximum inner diameter D4 and a minimum inner diameter when not squeezed. The maximum inner diameter D4 is located at an upper end portion of the second annular section 154b, and the minimum inner diameter is located at the distal end 157 of the second annular section 154b (when not squeezed). The maximum inner diameter D4 is greater than the outer diameter D3 of the lens module 130. Therefore, the lens module 130 may be easily assembled into the second annular section 154b. The outer diameter D3 of the lens module 130 is greater than the minimum inner diameter to ensure that when the lens module 130 is assembled into the second annular section 154b, the distal end 157 of the second annular section 154b may be closely fitted to the peripheral side of the lens module 130 to form the sealed area Z to prevent water vapor from entering.

In summary, the first annular section of the elastic member of the lens device of the disclosure is disposed between the cover and the housing and contacts the cover and the housing, and the second annular section of the elastic member contacts the peripheral side of the lens module, so that the sealed area is formed between the cover, the elastic member, and the lens module, which can reduce the probability of water vapor penetrating into between the cover and the lens module to provide an anti-fog effect. At the same time, the flexibility of the elastic member 150 may prevent the lens module 130 from being pushed by an excessive external force, which causes the focus point to shift.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A lens device, comprising:
a housing, comprising an opening and an accommodation space communicated with the opening;
a lens module, disposed in the housing and located in the accommodation space;
a cover, disposed in the opening and located above the lens module; and
an elastic member, comprising a first annular section and a second annular section, wherein the first annular section is disposed between the cover and the housing and contacts the cover and the housing, and the second annular section contacts a peripheral side of the lens module, so that a sealed area is formed between the cover, the elastic member, and the lens module.

2. The lens device according to claim 1, wherein the second annular section comprises a surrounding wall portion and an annular abutment portion connected to the surrounding wall portion, the surrounding wall portion surrounds the lens module, and the annular abutment portion abuts the peripheral side.

3. The lens device according to claim 2, wherein the housing comprises an inner platform, the inner platform surrounds the lens module, the first annular section is supported on the inner platform, and the second annular section is located between the inner platform and the lens module.

4. The lens device according to claim 3, wherein there is a first deformable space between the surrounding wall portion and the inner platform.

5. The lens device according to claim 2, wherein the surrounding wall portion has a first inner diameter, the first inner diameter is greater than an outer diameter of the lens module, the annular abutment portion has a second inner diameter when not squeezed, and the outer diameter of the lens module is greater than the second inner diameter.

6. The lens device according to claim 2, wherein the annular abutment portion obliquely extends from a distal end of the surrounding wall portion toward a direction of the opening and is located between the surrounding wall portion and the peripheral side, so that there is a second deformable space between the annular abutment portion and the surrounding wall portion.

7. The lens device according to claim 2, wherein the annular abutment portion is in a C shape, and an opening of the annular abutment portion is away from the peripheral side.

8. The lens device according to claim 1, wherein the second annular section is tapered toward a direction away from the opening along an optical axis of the lens module.

9. The lens device according to claim 8, wherein the second annular section has a maximum inner diameter and a minimum inner diameter when not squeezed, the maximum inner diameter is greater than an outer diameter of the lens module, and the outer diameter of the lens module is greater than the minimum inner diameter.

10. The lens device according to claim 1, wherein a thickness of the second annular section is less than a thickness of the first annular section.

11. The lens device according to claim 1, wherein the housing comprises an inner wall and an inner platform disposed on the inner wall, the inner wall and the inner platform surround the lens module, the first annular section is supported on the inner platform, and the second annular section is located between the inner platform and the lens module.

12. The lens device according to claim 1, wherein the elastic member further comprises a third annular section connected between the first annular section and the second annular section and obliquely expanding toward a direction of the opening along an optical axis of the lens module.

13. The lens device according to claim 12, wherein the first annular section, the second annular section, and the third annular section of the elastic member are integrally formed.

14. The lens device according to claim 11, wherein the inner platform comprises a planar portion, the first annular section comprises a first portion attached to a lower surface of the cover, and the first portion is sandwiched between the lower surface of the cover and the planar portion.

15. The lens device according to claim 14, wherein the first annular section comprises a second portion, and the second portion is sandwiched between a side surface of the cover and the inner wall.

16. The lens device according to claim 15, wherein a thickness of the second portion is less than a thickness of the first portion.

17. The lens device according to claim 1, further comprising a holder, wherein the holder is disposed in the housing and is located in the accommodation space, and the lens module is disposed on the holder.
